(19) United States
(12) Patent Application Publication
(10) Pub. No.: US 2009/0309266 A1
(43) Pub. Date: Dec. 17, 2009

(54) REACTION INJECTION MOLDING SYSTEM AND PROCESSES FOR PRODUCING POLYURETHANE ARTICLES

(76) Inventors: Thomas H. PETER, Southbury, CT (US); Mark P. Ferrandino, Danbury, CT (US)

Correspondence Address: PATENT ADMINISTRTOR;CHEMTURA CORPORATION, 199 Benson Road, Middlebury, CT, 06749, US

(21) Appl. No.: 12/139,036

(22) Filed: Jun. 13, 2008

(51) Int. Cl. B29C 45/00

(52) U.S. Cl. 264/328.14; 425/547

(57) ABSTRACT

An externally heated reaction injection molding (“RIM”) system and processes for producing polyurethane articles. The system comprises a mixing chamber for combining a prepolymer and a chain extender and one or more heating systems for heating at least one of the prepolymer and the chain extender upstream of the mixing chamber. In one embodiment, the process comprises injecting a heated prepolymer and/or a heated chain extender into a mixing chamber and initiating a curing of the prepolymer in a mixing chamber. By employing heat to decrease the viscosity of the prepolymer and/or the chain extender, prepolymers and/or chain extenders that have high room temperature viscosities or are in the solid state at room temperature, may be utilized in the RIM system.

### FIELD OF THE INVENTION

The present invention relates to reaction injection molding (“RIM”) systems and processes. More specifically, the present invention relates to heated RIM systems and processes for producing polyurethane articles.

### BACKGROUND OF THE INVENTION

Polyurethane articles suitable for high performance applications are typically made from components that are high in viscosity or solid at room temperature, such as high viscosity or solid polyurethane prepolymers and/or high viscosity or solid chain extenders. Such polyurethane articles may have high abrasion resistance, high cut and tear resistance, high temperature resistance, high load carrying ability, high fatigue resistance and/or low hysteresis (internal heat build up). In the production of such high performance articles, raw materials and prepolymer formulation methods are chosen to best meet the stringent end use requirements of the article. Accordingly, the ability to use high viscosity materials or formulations is of paramount importance. Processes to make such polyurethane articles, e.g., processes that utilize high performance polyurethane formulations, have generally been limited to those which use low pressure meter-mix equipment. In such equipment, a first stream comprising a prepolymer component and a second stream comprising a chain extender component flow into a mixing chamber that contains a dynamic mixing shaft with multiple mixing elements attached thereto. The walls of the mixing chamber may be smooth or have static mixing elements to complement those mixing elements on the dynamic shaft. The shaft is typically driven by a motor that produces on the order of 1,000 to 10,000 rpm to mix these component streams. The homogenous mixture is then discharged into a mold, such as an open mold, and allowed to cure. The mold is commonly placed in an oven, preferably until the part can be demolded. This time period can be from 1 to 120 minutes, e.g., from 10 to 90 minutes, from 20 to 60 minutes or from 30 to 60 minutes. The demolded part can then be returned to an oven for a time, e.g., from 1 to 48 hours or from 8 to 24 hours, to complete the curing process.

Such processes have several drawbacks that limit their effectiveness in making polyurethane articles. First, the starting and stopping of such equipment creates problems. When the streams are shut off, the mixing chamber must be cleaned using a solvent or a combination of solvent and gas, such as air. This cleaning results in wasted material as well as a waste stream of solvents that require disposal. Second, the initial mixture released from the mixing chamber typically contains bubbles and is discarded resulting in waste.

An additional disadvantage is decreased productivity. Because the mixing chamber is large, longer gel time formulations of about 1 to 10 minutes are utilized to prevent fouling of the mixing chamber and to help alleviate some of the problems created with starting and stopping of the equipment. Such starting and stopping is inefficient when compared to continuous molding operations. In continuous molding processes, material discharged between molds is collected in a container while switching from one mold to the next. Alternatively, all of the molds may be filled by collecting material in containers and filling the molds with the material from the containers. While these operating schemes serve to limit the number of wasteful start and stop operations performed on the mix machine, additional waste is created when the cured material coats the container. The long gel time formulations utilized to limit this waste lengthen demold time, resulting in either much lower productivity or a far greater number of molds and associated equipment, e.g., ovens.

The production of polyurethane articles suitable for high performance applications has been difficult if not impossible to achieve with conventional RIM processes due to the inability to utilize components that are high in viscosity or solid at room temperature, e.g., high viscosity or solid polyurethane prepolymers and/or high viscosity or solid chain extenders. Thus, the need exists for processes and systems for producing high performance polyurethane articles that are effective and cost efficient and that have the capability to utilize components that are high in viscosity or solid at room temperature.

### SUMMARY OF THE INVENTION

The present invention relates to reaction injection molding (RIM) systems and processes for forming high performance polyurethane articles.

In one embodiment, the invention is directed to an externally heated reaction injection molding system in communication with a prepolymer storage vessel and a chain extender storage vessel. The system optionally comprises a mixing chamber for combining a prepolymer and a chain extender; and a heating system for heating at least one of the prepolymer and the chain extender upstream of the mixing chamber and downstream of the storage vessels. The heating system preferably heats one or more conduits between the mixing chamber and at least one of the prepolymer storage vessel or the chain extender storage vessel. At least one of the prepolymer storage vessel or the chain extender storage vessel optionally are heated.

Preferably, the system is capable of heating at least one of the prepolymer and the chain extender to a temperature greater than 70° C., e.g., greater than 100° C. By heating one or more of these materials, the system preferably is capable of employing at least one of a prepolymer and a chain extender having a room temperature viscosity greater than 3000 centipoise and which optionally is a solid at room temperature. The system preferably is capable of employing at least one of a prepolymer or a chain extender having a melting point in the range of 40° C.-140° C.

In one embodiment, the system further comprises a first conduit in fluid communication with the prepolymer storage vessel; a first pump in fluid communication with the prepolymer storage vessel for pumping prepolymer through the first conduit to the mixing chamber; a second conduit in fluid communication with the chain extender storage vessel; and a second pump in fluid communication with the chain extender storage vessel for pumping chain extender through the second conduit to the mixing chamber.

In one aspect, the system further comprises a first heating system for independently heating the prepolymer and a second heating system for independently heating the chain extender. The first heating system may comprise a first heated fluid that circulates around at least a portion of the prepolymer storage vessel, and the second heating system may comprise a second heated fluid that circulates around at least a portion of the chain extender storage vessel.

In order facilitate mixing in the RIM system, the mixing chamber preferably includes an L head for mixing the prepolymer and the chain extender. As a result, the system may be capable of combining (and preferably completely mixing) the prepolymer and the chain extender at a weight ratio of from 3:1 to 10:1 or greater than 5:1.

In another embodiment, the invention is to a process for producing an article in a reaction injection molding system, the process comprising the steps of: (a) injecting a prepolymer and a chain extender into a mixing chamber, wherein at least one of the prepolymer and the chain extender is heated; and (b) initiating a curing of the prepolymer in the mixing chamber, wherein the prepolymer and the chain extender have a gel time greater than 2 seconds, e.g., greater than 4 seconds.

In another embodiment, the invention is a process for producing an article in a reaction injection molding system, the process comprising the steps of: (a) injecting a prepolymer and a chain extender into a mixing chamber to form a reaction mixture, wherein at least one of the prepolymer or chain extender is heated to reduce its viscosity by at least 2000 centipoise relative to room temperature; (b) directing the reaction mixture into a mold; and (c) curing the reaction mixture to form the article. As with the previous embodiment, the prepolymer and the chain extender preferably have a gel time greater than 2 seconds, e.g., greater than 4 seconds.

In the processes of the invention, at least one of the prepolymer and the chain extender that is heated preferably has a viscosity at 25° C. that is greater than 3000 centipoise, e.g., greater than 5000 centipoise or optionally in solid form. The viscosity of the at least one of the prepolymer and the chain extender that is heated ideally is reduced by at least 2000 centipoise, e.g., by at least 4000 centipoise. The temperature of the heating may vary widely. Preferably, at least one of the prepolymer and the chain extender is heated to a temperature above 70° C., e.g., above 100° C. The process optionally further comprises the step of heating the mixing chamber. In a preferred embodiment, the process further comprising the step of independently heating at least one of the prepolymer and the chain extender.

The prepolymer preferably has a melting point in the range of greater than 60° C., e.g., from 60° C.-120° C. The prepolymer ideally has a NCO content of less than 15%, e.g., from 2 to 12%. At least one of the prepolymer and the chain extender preferably has a melting point below 50° C. The prepolymer may, for example, be a toluene diisocyanate(“TDI”)-based prepolymer or a diphenylmethane diisocyanate (“MDI”)-based prepolymer.

The chain extender preferably has a melting point in the range of 40° C.-140° C. or greater than 60° C. As examples, the chain extender may be a halogenated aromatic diamine or a halogenated diaromatic diamine. The chain extender optionally is selected from the group consisting of methylene bis orthochloroaniline (MOCA), methylene bis diethylanaline (MDEA), methylene bis chlorodiethylanaline (MCDEA), and hydroquinone-bis-hydroxyethyl ether (HQEE).

In some exemplary preferred combinations, the prepolymer is MDI-based and the chain extender is DMTDA; the prepolymer is TDI-based and the chain extender is selected from the group consisting of MDEA and MCDEA; the prepolymer is TDI-based and the chain extender is DETDA; or the prepolymer is MDI-based and the chain extender is selected from the group consisting of MOCA and MCDEA. In another combination, the prepolymer is the reaction product of a polyol and an aromatic diisocyanate and the chain extender is a diaromatic diamine.

The resulting article preferably is highly durable and exhibits high performance properties. For example, the resulting article preferably has a hardness of 45 to 85 Shore D and preferably softens by less than 30 Shore D units when heated to 150° C.

### BRIEF DESCRIPTION OF THE DRAWINGS

The present invention will be better understood in view of the non-limiting figures, wherein like characters refer to the same or similar parts throughout the views, and in which:

FIG. 1A is a schematic diagram of a heating system for a RIM system arranged in accordance with an embodiment of the present invention;

FIG. 1B is a schematic diagram of two heating systems for a RIM system arranged in accordance with an embodiment of the present invention;

FIG. 1C is a schematic diagram of a heating system for one vessel of a RIM system arranged in accordance with an embodiment of the present invention;

FIG. 2 is a Table summarizing the material properties of polyurethane articles formed in Examples 1-13;

FIG. 3 is a Table summarizing the material properties of polyurethane articles formed in Comparative Examples A-H; and

FIG. 4 is a Table summarizing the material properties of polyurethane articles formed in Comparative Examples I-O.

### DETAILED DESCRIPTION OF THE INVENTION

### Introduction

The present invention relates to reaction injection molding (RIM) systems and processes for producing polyurethane articles, preferably high performance polyurethane articles. RIM processes and systems rapidly mix two components, such as a prepolymer mixture and a chain extender, on a continuous basis and without a dynamic mixer or other moving mixer parts. Instead, the mixing is accomplished by the impingement of two high pressure streams that are sprayed toward one another in a mixing chamber. The mixed components begin to react in the mixing chamber and exit into a mold. Typically, the mixing chamber is a small cylindrical tube that includes a hydraulically driven control rod that serves to simultaneously shut off flow and clean out the tube when the rod is pushed forward toward the mold. Also the control rod may start the flow of both streams into the chamber and, subsequently, into a mold when the rod is pulled back away from the mold. Conventional RIM systems employ low viscosity prepolymers and chain extenders and cannot form high performance polyurethane articles from prepolymers and chain extenders, either or both of which are solid or have relatively high viscosities at 25° C. The RIM systems and processes of the present invention provide the ability to form such high performance articles from these high viscosity or solid materials. More specifically, the present invention relates to an externally heated RIM system and RIM processes for producing polyurethane articles, preferably high performance polyurethane articles, as defined herein, from prepolymers and/or chain extenders that are solid or have high viscosities at room temperature.

One advantage of the present invention is that high performance polyurethane articles having properties ordinarily obtained only through dynamic meter-mixing may be produced using the modified RIM system. Without heating to decrease viscosities, such high viscosity prepolymers and/or high viscosity chain extenders, as described in greater detail below, could not be effectively pumped, mixed or otherwise processed in standard RIM systems. Therefore, solid or high viscosity prepolymers and solid or high viscosity chain extenders could not be used in conventional RIM systems, and, accordingly, high performance polyurethane articles having properties similar to articles obtained through meter-mixing could not be produced through conventional RIM systems.

### Heated RIM Systems and Processes

At least a portion of the RIM system of the invention preferably is heated internally or, more preferably, heated externally using one or more heating systems. For example, in one aspect, the RIM system comprises one or more jackets that surround a portion of the RIM system. In this embodiment, one or more heating elements or heating units may, for example, heat a fluid, e.g., an oil, which is pumped through the jackets such that one or more of the components, e.g., the prepolymer and/or the chain extender, used in the RIM system are maintained at an elevated temperature in order to reduce the viscosity of either or both components and render them suitable for a RIM process.

Alternatively, the temperature of the system or portions thereof may be elevated with other heating elements known in the art, e.g., electrical heat tracing or a heated air chamber. In a preferred embodiment, the elevated temperature at which one or more of the components are maintained is greater than 60° C., e.g., greater than 80° C., greater than 100° C. or greater than 120° C. In terms of ranges, the elevated temperature optionally ranges from 30° C. to 140° C., e.g., from 50° C. to 135° C., or from 60° C. to 120° C. In a preferred aspect, the RIM system is externally heated such that at least one of the components used to make the polyurethane elastomer is heated and has a heated viscosity that renders it suitable for RIM processing. For example, the heated component or components, e.g., heated prepolymer and/or heated chain extender, may have a heated viscosity that is less than 3000 centipoise, e.g., less than 2000 centipoise or less than 1000 centipoise. In another embodiment, the RIM system is externally heated such that the viscosity of at least one of the components used to make the polyurethane elastomer, e.g., the heated prepolymer and/or the heated chain extender, is reduced by at least 2000 centipoise, e.g., by at least 3000 centipoise or by at least 4000 centipoise, in relation to the viscosity of the respective component at 25° C. At such reduced viscosities, the components may be injected into a mixing chamber and sufficiently mixed under RIM mixing conditions to form a high performance polyurethane elastomer.

In one embodiment, at least a portion of the RIM system is heated, e.g., externally heated, in order to decrease the viscosity of the prepolymer and render the prepolymer suitable for RIM. In this embodiment, the RIM systems of the present invention are capable of using prepolymers having a viscosity at room temperature (25° C.) that is greater than 3000 centipoise, e.g., greater than 5000 centipoise, greater than 8000 centipoise, greater than 10,000 centipoise, greater than 20,000 cPs or in a solid state, which is defined herein as having a viscosity greater than 40,000 cPs. Such prepolymers may or may not require chain extenders that are high in viscosity or solid at room temperature in order to meet the performance needs of the article. In this aspect, the chain extender that is employed in the RIM system may or may not be heated. Thus, conventional RIM chain extenders may be employed in this aspect of the invention.

Conversely, in another embodiment, at least a portion of the RIM system is heated, e.g., externally heated, in order to decrease the viscosity of the chain extender, e.g. melt the chain extender, and render the chain extender suitable for RIM. In this embodiment, the externally heated RIM system may employ a chain extender, for example, having a viscosity at 25° C. that is greater than 3000 centipoise, e.g., greater than 5000 centipoise, greater than 8000 centipoise, greater than 10,000 centipoise, greater than 20,000 cPs or in a solid state, as defined above. Such chain extenders may or may not require the use of prepolymers that are high in viscosity or solid at room temperature in order to meet the performance needs of the article. In this aspect, the prepolymer that is employed in the RIM system may or may not be heated. Thus, a conventional RIM prepolymer may be employed in this aspect of the invention.

In another embodiment, the RIM system may be externally heated to decrease the viscosities of both the prepolymer and the chain extender.

Thus, by heating either or both the prepolymer and/or the chain extender, the externally heated RIM system may be capable of employing a prepolymer and a chain extender, either or both of which have a viscosity at 25° C. that is greater than 3000 centipoise, e.g., greater than 5000 centipoise, greater than 8000 centipoise, greater than 10,000 centipoise, greater than 20,000 cPs or in a solid state.

In a preferred embodiment, the prepolymer and the chain extender are heated independently of one another. This aspect is desirable in that it provides the ability to carefully and independently control the viscosities of the prepolymer and the chain extender in those circumstances in which the prepolymer and chain extender have elevated temperature viscosities that differ, perhaps significantly, from one another. Under such circumstances, each component may require a different degree of heating in order to achieve a viscosity suitable for RIM processing. For example, a prepolymer may require a temperature of 70° C. to be reduced to a viscosity of 3000 centipoise, while the chain extender may require a temperature of 100° C. simply to melt.

In another embodiment, there is provided a RIM process for forming an article, in which the viscosity of at least one of the prepolymer or chain extender is reduced through heating by at least 2000 centipoise, e.g., at least 3000 centipoise or at least 4000 centipoise, relative to the viscosity of the composition at room temperature. The prepolymer and chain extender are injected into a mixing chamber to form a reaction mixture, which is subsequently directed into a mold and cured to form the article. The process is capable of utilizing prepolymers and chain extenders having at least some of the characteristics listed above.

### Prepolymers

Industrial polyurethane elastomers are based on polyurethane prepolymers that are formed by reacting polyols with excess molar amounts of diisocyanate monomers. For purposes of the present specification, the term “prepolymer” refers to the prepolymer as well as any unreacted diisocyanate monomer mixed therewith. Polyurethane prepolymers may be obtained by reacting one or more polyols with the diisocyanate monomer by procedures known in the art. See, for example, U.S. Published Patent Application No. 2003/0065124, filed Aug. 2, 2001, the entirety of which is incorporated herein by reference. In such procedures, the molar ratio of diisocyanate to polyol may be, for example, in the range of from 1.5:1 to 20:1. For diphenylmethylene diisocyanate (MDI)-based prepolymers, the molar ratio of MDI to polyol may be from 2.5:1 to 20:1. For a toluene diisocyanate (TDI)-based prepolymer, the molar ratio of TDI to polyol may be from 1.5:1 to 4:1. The diisocyanate and polyol preferably are reacted at a temperatures ranging from 30° C. to 120° C., e.g. 50° C. to 110° C.

The polyols may comprise, for example, polyether, polyester, polycaprolactone and polycarbonate or hydrocarbon polyols having molecular weights ranging, for example, from about 200 to about 6000, e.g., about 400 to about 3000. Such polyols include polyester of adipic acid, homo and copolyethers of ethylene and propylene oxide, polyether of tetrahydrofuran, polycarbonate, hydrocarbon polyol, and mixtures thereof. In one embodiment, the polyols may comprise glycols or triols having molecular weights from about 60 to about 400, e.g., about 80 to about 200. Such glycols or triols include ethylene glycol, isomers of propylene glycol, isomers of butane diol, hexanediol, trimethylolpropane, pentaerythritol, poly(tetramethylene ether) glycol, diethylene glycol, triethylene glycol, dipropylene glycol, tripropylene glycol, and mixtures thereof.

Representative polyols include polypropylene glycol (PPG) such as Acclaim 4220 (mw=4037) Bayer MaterialScience, PPG diol polymer from propylene oxide (“PPG 4000), Acclaim 3201 (mw=3074) Bayer MaterialScience, PPG-EO diol (copolymer from propylene oxide and ethylene oxide) (PPG-EO 3000), Arcol R-2744 (mw=2240) Bayer MaterialScience, PPG diol (PPG 2000), poly(ethylene adipate) glycol (PEAG) such as PEAG 1000 (mw=980) Chemtura Corporation, PEAG 2000 (mw=1990) Chemtura Corporation, and PEAG 2500 (mw=2592), Ruco Polymer Corp., poly(trimethylolpropane ethylene adipate) glycol (PTEAG), poly(tetramethylene ether) glycol (PTMEG), such as Terathane™ 1000 (mw=994) Invista, Terathane™ 2000 (mw=2040) Invista, tripropylene glycol (mw=192), Aldrich Chemical Company, Inc., and diethylene glycol (mw=106), Aldrich Chemical Company, Inc.

The diisocyanate monomers that may be reacted with the polyols to form the prepolymer may include, for example, aromatic diisocyanates, such as MDI, including pure monomeric MDI, various modified MDI and polymeric MDI materials known in the art, e.g., ester MDI and ether MDI, TDI including, for example, 2,4 TDI and 2,6 TDI and mixtures thereof, naphthalene diisocyanate (NDI), 3,3′-bitoluene diisocyanate (TODI), and para-phenylene diisocyanate (PPDI), and aliphatic diisocyanates, such as 1,6-hexane diisocyanate (HDI), isophorone diisocyanate (IPDI), and methylene bis (p-cyclohexyl isocyanate) (H₁₂MDI).

In a preferred embodiment, the prepolymer, optionally a high viscosity prepolymer, that is employed in the RIM system of the present invention is MDI-based. In another preferred embodiment, the prepolymer, optionally a high viscosity prepolymer, is TDI-based. Optionally, the prepolymer is formed from a blend of these monomers.

One important factor in determining prepolymer viscosity is the type of polyol used to produce the prepolymer. Homo and copolyethers of ethylene and propylene glycol (PPG polyols) with molecular weights of 2000 or less generally give prepolymers with relatively low viscosity at room temperature. Most other polyols, including polyesters of adipic acid, polytetramethylene ether glycols, polycaprolactones, polycarbonates, and hydrocarbon polyols generally give higher prepolymer viscosities. As such, the PPG polyols have been preferred for existing room temperature RIM operations. However, the properties that can be obtained from such PPG polyols are also generally lower than those obtained from other, more viscous polyols. Recent advances by producers of PPG polyols have lead to higher molecular weight polyols, e.g., greater than 2000, greater than 3000 or greater than 4000, with reportedly better properties over lower molecular weight polyols. However, the higher molecular weight of these polyols also results in prepolymers that are generally too high in viscosity for conventional RIM processes and systems.

Another important factor determining prepolymer viscosity is the amount of excess isocyanate used in producing the prepolymer. When TDI is the isocyanate used, the potential for industrial hygiene issues from excess TDI is great (because of the relatively high vapor pressure of TDI), and, thus, only relatively low amounts of excess isocyanate can be used, e.g., 1.5:1 to 4:1, 1.6:1 to 3.5:1, or 1.7:1 to 3.0:1, NCO:OH. When MDI is the isocyanate used, the potential for such industrial hygiene issues is lower (because of the very low vapor pressure of MDI), and a wider range of excess MDI levels is used, e.g., 2.5:1 to 20:1, 3:1 to 15:1, or 3.5:1 to 10:1, NCO:OH. High NCO:OH ratio prepolymers (TDI and MDI) result in lower viscosity prepolymers, and, thus, high NCO:OH MDI based prepolymers have been preferred for existing room temperature RIM operations. However, the properties that can be obtained from such high NCO:OH MDI prepolymers are generally lower than those obtained from higher viscosity MDI and TDI prepolymers made with low NCO:OH.

Thus, the resultant preferred prepolymers suitable for forming high performance polyurethanes, as indicated above, may have high viscosities at room temperature, such as viscosities greater than 3000 centipoise, e.g., greater than 5000 centipoise, or greater than 8000 centipoise, or may be in the solid state at room temperature. Exemplary ester MDI-based prepolymers include Vibrathane™ 8585, Vibrathane™ 8595, and Vibrathane™ 8572 made by Chemtura Corporation. Exemplary ether MDI-based prepolymers include Vibrathane™ B625, Vibrathane™ B670, Vibrathane™ B635 and Vibrathane™ B836 made by Chemtura Corporation. With the exception of Vibrathane™ B670 and Vibrathane™ B635, the above-mentioned prepolymers are solids at room temperature. Vibrathane™ B670 and Vibrathane™ B635 are high viscosity liquids at room temperature.

In one embodiment, the prepolymer has an NCO content of less than 15%, e.g., less than 12%, less than 10%, less than 6%, less than 4% or less than 3%. In terms of ranges, the NCO content of the prepolymer optionally ranges from 2 to 15%, e.g., from 2.5 to 12%, from 3 to 12%, from 3 to 9%, or from 2 to 4%.

### Chain Extenders

Once formed, the prepolymers and prepolymer mixtures are chain-extended by various chain extenders in the RIM systems and processes of the present invention. The chain extender may comprise, for example, water, diols, triols, diamines, triamines or their mixtures. As indicated above, the chain extender optionally has a high viscosity at room temperature, which is reduced upon heating in the heated RIM system of the present invention. Optionally, the chain extender is in a solid state at room temperature.

Representative diol chain extenders suitable for use in the RIM systems of the present invention include 1,4-butanediol (BDO), resorcinol di (beta-hydroxyethyl) ether (HER), resorcinol di(beta-hydroxypropyl) ether (HPR), hydroquinone-bis-hydroxyethyl ether (HQEE), 1,3-propanediol, ethylene glycol, 1,6-hexanediol, and 1,4-cyclohexane dimethanol (CHDM); triols and tetrols, such as trimethylol propane and triethanolamine; and adducts of propylene oxide and/or ethylene oxide having molecular weights in the range of from about 190 to about 500, e.g., about 250 to about 400, such as various grades of Voranol™ (Dow Chemical), Pluracol™ (BASF Corp.) and Quadrol™ (BASF Corp.).

Representative diamine chain extenders suitable for use in the RIM processes and systems of the present invention include 4,4′-methylene-bis(3-chloro-2,6-diethylaniline) (MCDEA); diethyl toluene diamine (DETDA, Ethacure™ 100 from Albemarle Corporation); tertiary butyl toluene diamine (TBTDA); dimethylthio-toluene diamine (Ethacure™ 300 from Albemarle Corporation); trimethylene glycol di-p-amino-benzoate (Vibracure™ A157 from Chemtura Company, Inc. or Versalink™ 740M from Air Products and Chemicals); methylenedianiline (MDA); methylenedianiline-sodium chloride complex (Caytur™ 21 and 31 from Chemtura Company); halogenated aromatic diamines, halogentated diaromatic diamines, such as methylene bis orthochloroaniline (MOCA); and methylene bis diethylanaline (MDEA).

Chain extenders may be used alone to cure the polyurethane prepolymer, or alternatively, may be mixed with low to moderate amounts of hydroxy or amine terminated polyol to make a mixed curative. Addition of such hydroxy or amine terminated polyols has the effect of increasing the equivalent weight of the curative blend, as well as of softening the final polyurethane article that is molded. While this can be beneficial either when improved ratios are desired for easier mixing, or when low hardness is needed, the use of such polyols is known in the art to compromise physical and dynamic properties. Therefore, use of such hydroxy or amine terminated polyols is preferably limited to less than 50 mole % e.g. less than 30 mole %, or less than 20 mole % of the curative mixture.

In addition to the ability to use prepolymers having high room temperature viscosities, the present invention provides the advantage of optionally utilizing chain extenders that are solid or have high viscosities, e.g., viscosities greater than 3000 centipoise, greater than 5000 centipoise or greater than 8000 centipoise, as measured at room temperature. Further, chain extenders that are solids at room temperature may be used with the embodied processes and systems of the present invention. Examples of preferred chain extenders include aromatic diamines, e.g., diaromatic diamines, e.g., halogenated diaromatic diamines. Specific examples include MOCA, MDEA and MCDEA. Another exemplary chain extender is HQEE.

When a chain extender that is solid at room temperature, e.g., MOCA, MDEA and MCDEA, is utilized in accordance with embodiments of the present invention, the solid chain extender is heated thereby yielding a liquid chain extender having a viscosity suitable for being utilized in a RIM process.

### Preferred Prepolymer and Chain Extender Combinations

Another advantage of the RIM processes and systems of the present invention is that they provide the ability to use combinations of chain extenders and prepolymers that result in gel times less than 60 seconds, e.g., less than 30 seconds or less than 10 seconds. Such combinations are typically not utilized in conventional dynamic meter-mixing systems because the fast cure time would foul the mixing chamber and cause poor mixing, or cause the moving mixer parts to seize. A non-limiting example of a fast curing combination is Vibrathane™ 8595 cured with MOCA. Another example is Adiprene™ LF1900 cured with MDEA. Accordingly, the RIM systems and processes of the present invention provide the ability to employ combinations of prepolymers and chain extenders that are react quickly, e.g., a MDI prepolymer and MOCA combination, that had not previously been feasible in meter-mixing processes.

In one embodiment, the heating in a RIM process and system of the above-identified prepolymers (e.g., high viscosity prepolymers or solid prepolymers) and/or chain extenders (e.g., high viscosity chain extenders or solid chain extenders) may facilitate production of high performance polyurethane articles having properties similar to articles obtained through meter-mixing in a cost effective process.

In one preferred embodiment, a MDI-based prepolymer and a MOCA chain extender are reacted via the RIM process and system to produce a polyurethane article. One suitable prepolymer is an ester MDI-based prepolymer such as Vibrathane™ 8595 prepolymer. Such a combination may produce a polyurethane article with a high hardness value, e.g., a Shore D hardness in the range of 45 to 85, or 50 to 80. Upon heating to 150° C. such a polyurethane article softens by less than 30 Shore D units, e.g. less than 20 Shore D units. Such a polyurethane article has a low thermoplasticity when compared to an article produced via a dynamic meter-mixed system. As an example, an article of Vibrathane™ 8595 cured with MOCA and processed via a RIM system, is improved over an article of Vibrathane™ 8570 cured with MOCA. Alternatively, other ester MDI-based prepolymers such as Vibrathane 8585 and Vibtathane™ 8572 are utilized. As another alternative, ether MDI-based prepolymers, such as Vibrathane™ B625, Vibrathane™ B635 and Vibrathane™ B670 are utilized.

Various novel combinations of prepolymers and chain extenders may be employed in the RIM processes and systems of the present invention. In one embodiment, for example, the prepolymer is TDI-based and the chain extender is selected from the group consisting of MDEA and MCDEA. In particular, the MDEA-cured TDIs produced using embodiments of the present invention provide dynamic performance comparable to the dynamic performance expected of a high performance hot cast polyurethane. In another embodiment, the prepolymer is TDI-based and has a high diisocyanate content and the chain extender comprises MCDEA.

The simple mixing configuration of RIM systems allows an operator to use a fast reacting system that takes from 1 to 40 seconds, e.g., 2 to 20 seconds or 5 to 10 seconds, which is economically desirable. In preferred embodiments, the combination of prepolymer and chain extender have a gel time from 3 to 60 seconds, e.g., from 5 to 60 seconds.

In a RIM system, generally speaking, fast reacting prepolymer/chain extender mixtures do not foul or gel the mixing chamber because the residence time of the mixture in the mixing chamber is very low, e.g., less than 0.5 seconds or less than 0.2 seconds. Gel times less than 3 seconds, and particularly less than 2 seconds, however, are generally less desired due to problems in processing that may result for such prepolymer/chain extender combinations. In addition to processing problems, such short gel times require either the use of a very large RIM machine, or greatly limit the size of parts that can be molded. This is because of the poor flow that results from the increasing viscosity as the mold fills. Also, large RIM machines are less desirable not only because of considerably higher cost, but because the high flow rates increase velocity and turbulence in the mold, resulting in increased likelihood of bubble entrapment issues. In addition, gates, runners, dams, and vents all need to be increased in size, resulting in increased waste. Thus, the combination of prepolymer and chain extender preferably are selected such that they provide a gel time greater than 2 seconds, e.g., greater than 3 seconds, greater than 4 seconds, or greater than 5 seconds. In this context, “gel time” means the time period between the mixing of the prepolymer and chain extender and the point at which a 1 second test shot in a cup no longer flows at all (no movement when turned 90° to the side).

Also, fouling is limited because the control rod provides positive mechanical cleanout of the mixing chamber when shut off. This provides the operator ample time to open the mold, remove the formed article, clean the mold, prepare the mold for the next injection, close the mold, and inject more components to produce another article. The process is economical because only a few minutes is required before a polyurethane article may be demolded. Also, fewer molds are needed to achieve high productivity as compared to other processes.

### Exemplary RIM Systems

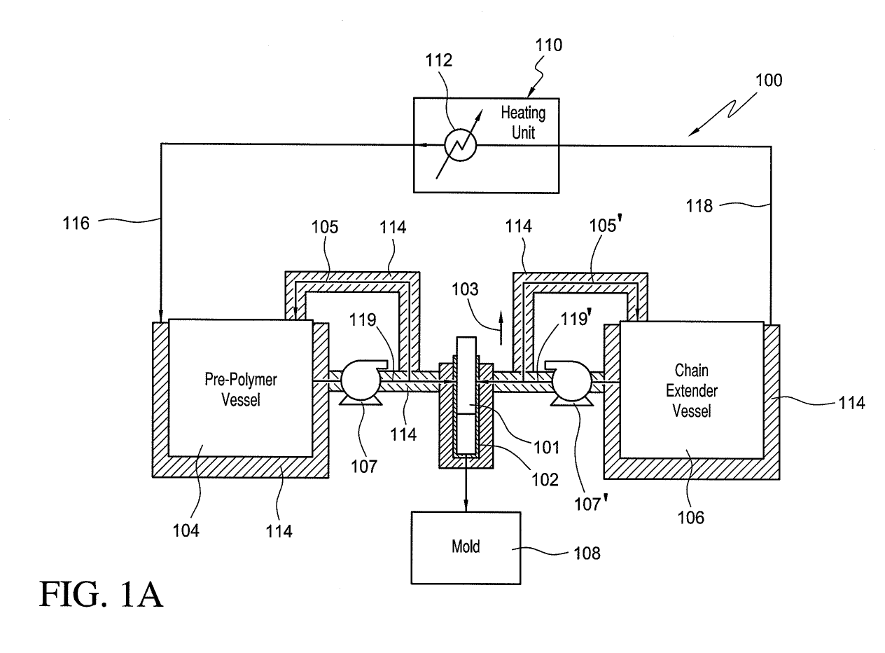

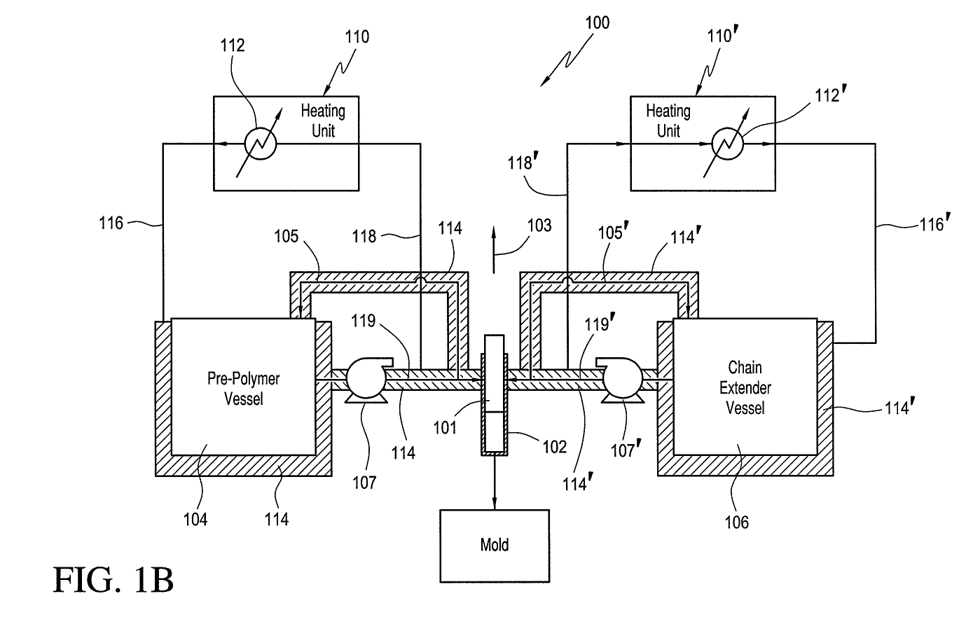

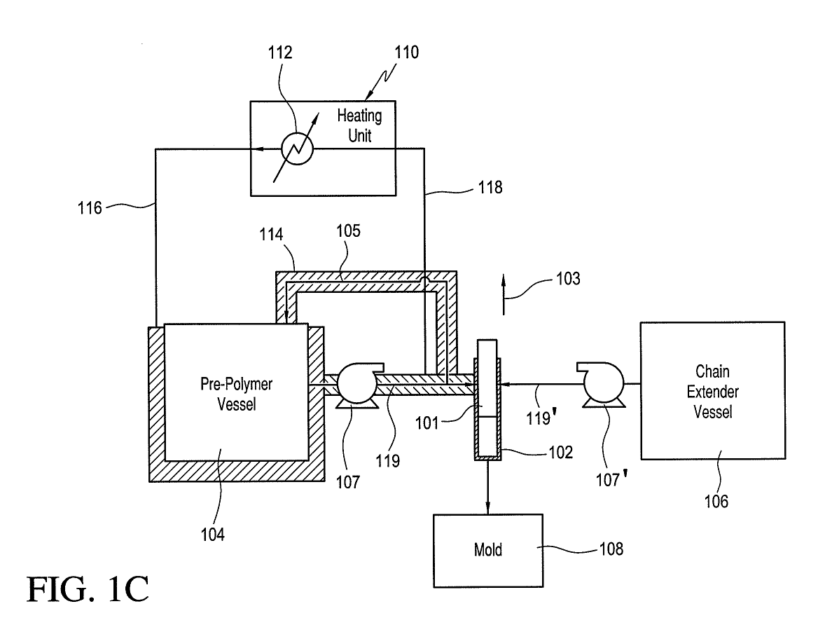

FIG. 1A is a schematic diagram of an exemplary RIM system 100 according to one embodiment of the present invention. The RIM system 100 comprises a mixing chamber 102, prepolymer vessel 104, prepolymer pump 107, chain extender vessel 106, chain extender pump 107′, feed conduits 119 and 119′, recirculation conduits 105 and 105′ and mold 108. Optionally, the prepolymer vessel 104 and chain extender vessel 106 may be a storage vessel. Vessels 104, 106 preferably serve to supply the respective component to the RIM system. Accordingly, other devices known to those skilled in the art to supply the components may be utilized.

To initiate operation of the RIM system 100, high pressure recirculation is established through feed conduits 119 and 119′ and recirculation conduits 105 and 105′. High pressure is supplied by pumps 107 and 107′, which are of a type known in the art, e.g., rotary piston pumps, radial piston pumps, gear pumps, hydraulic or mechanically driven cylinder pumping devices. Other devices suitable for obtaining pressures of at least 500 psi (3447 kPa), e.g., at least 1000 psi (6895 kPa) or at least 1500 psi (10342 kPa) can be utilized. In one embodiment, pump 107 pumps the prepolymer from the prepolymer vessel 104 to the mixing chamber 102 via feed conduit 119, which conveys pressurized prepolymer. Similarly, pump 107′ pumps the chain extender from the chain extender vessel 106 to the mixing chamber 102 via feed conduit 119′, which conveys pressurized chain extender. A control rod 101 is moved in the direction of arrow 103 and thereby opening conduits 119 and 119′ from vessels 104, 106, respectively, and allowing the prepolymer and chain extender to be introduced, e.g., sprayed or injected, into mixing chamber 102. In a preferred embodiment, recirculation conduits 105 and 105′ are closed at the time that conduits 119 and 119′ are opened to mix chamber 102 to ensure that all prepolymer and chain extender flowing through conduits 119 and 119′ is fed to mix chamber 102. When the control rod 101 is moved in the direction opposite arrow 103, no prepolymer and/or chain extender are introduced, e.g., sprayed or injected, into the mixing chamber 102. In this preferred embodiment, recirculation conduits 105 and 105′ are open so as to convey the respective prepolymer and chain extender from the respective feed conduit 119, 119′ back to the respective vessel 104, 106, thus establishing a high pressure circulation loop. In one embodiment, whenever the control rod is moved in the direction opposite arrow 103, e.g., when conduits 119 and 119′ are closed to the mixing chamber 102, recirculation conduits 105 and 105′ remain open and allow for the continued circulation of material. Optionally, this is simultaneously accomplished by same movement of control rod 101. In another embodiment, the recirculation conduits 105 and 105′ are at least partially open when feed conduits 119 and 119′ are open. Alternatively, a valve (not shown) external to the mix chamber is actuated to prevent material from entering conduits 105 and 105′ while materials are being fed to the mix chamber. The prepolymer from vessel 104 and chain extender from vessel 106 are injected or sprayed into mixing chamber 102 together and thoroughly mixed through impingement thereof in order to initiate a curing reaction between the two materials and forming a reaction mixture.

By continued introduction of prepolymer and chain extender into mixing chamber 102, the reaction mixture within mixing chamber 102 is directed from mixing chamber 102 to mold 108 where the reaction mixture of the prepolymer and chain extender is shaped to form the desired polyurethane article. Optionally, mold 108 is heated, e.g., placed in an oven or heated with heating oil, glycol, water, electrical resistance heaters, air or other forms of external heating, to facilitate curing of the reaction mixture. Once the mold is filled, the control rod 101 is optionally moved in a direction opposite arrow 103 in order to stop the flow of prepolymer from vessel 104 and chain extender from vessel 106 as well as mechanically clean mixing chamber 102. It will be appreciated that other elements commonly known in the art of RIM processes can be utilized in combination with the elements mentioned.

RIM system 100 also comprises a heating system 110 that comprises a heating unit 112, jacket 114, heating inlet line 116 and heating outlet line 118. The purpose of the heating system 110 is to heat a heating medium, e.g., fluid, which is then directed to jacket 114. The heated heating medium, e.g., fluid, optionally oil, in heating unit 112 enters jacket 114 through heating inlet line 116 and returns to heating unit 112 through heating outlet line 118. The fluid may be a commercially available heat transfer medium, e.g., one of the Dowtherm™ fluids from Dow Chemical Co. In other embodiments, the heating medium, e.g., heating fluid, is air, water, glycol, mixtures of water and glycol or another liquid with suitable temperature resistance, fluidity and heat transfer characteristics. Heating unit 112 may reheat the heating medium, e.g., fluid, and return the re-heated fluid to jacket 114. Heating system 110 externally heats the RIM system 100 such that the components in each vessel 104 and 106 maintain a viscosity sufficient to be injected into mixing chamber 102.

As shown in FIG. 1A, jacket 114 partially surrounds prepolymer vessel 104, chain extender vessel 106, the interconnecting feed conduits 105 and 105′ and recirculation conduits 119 and 119′ and parts of the RIM system 100. In other embodiments, various jackets partially surround each part of the RIM system 100. In still other embodiments, various jackets completely surround each part of the RIM system 100. The thickness of jacket 114 should be sufficient to allow proper flow of the heating fluid, and sufficient heat transfer to the systems being heated. Optionally, jacket 114 is further insulated with a temperature resistant insulating material, e.g., fiberglass or foam insulation, to reduce the loss of heat to the air surrounding the system, thereby reducing the overall heating load on heating system 110, as well as the flow requirements for the heating fluid.

In still other embodiments, fluid and/or oil tracing lines (not shown) are positioned adjacent the conduits and utilized in place of jacket 114. Such tracing lines may be added or removed from one or more parts of the RIM system as dictated by processing parameters, or as needed for maintenance purposes. Optionally, tracing lines are layered upon one another. As an example, multiple tracing lines may wrap around the interconnecting conduits in a concentric fashion. It should be understood to those skilled in the art that suitable tracing lines may surround, either partially or fully, the portion of the RIM system such that the viscosities of the prepolymer and/or the chain extender are sufficiently lowered.

Similarly, the heating system shown in FIG. 1A is exemplary, and other types of heating systems may be employed, such as, for example, electric heating coils, tracing, electrical resistance heaters, hot air chambers, and/or heating lamps. Of course, other types of heating systems known to those skilled in the art may be utilized. While fluid heat transfer systems are preferred, practicality often dictates that some parts of the system that are difficult to heat with fluid be heated by electrical resistance or other external heating method, even if fluid heating is used for the majority of the system, e.g., the tanks and all the main conduits. These parts that are difficult to heat include, for example, elbows, valves, pumps, meters, and the mix head. These parts may not lend well to jacketing or oil tracing.

Other suitable configurations of heating systems 110 of the present invention are shown in FIGS. 1B and 1C. In FIG. 1B, the RIM system 100 comprises two independent heating systems 110, 110′. Each heating system 110, 110′ comprises a respective heating unit 112, 112′ which is connected to a separate jacket 114, 114′ through respective heating inlet lines 116, 116′ and heating outlet lines 118, 118′. Jacket 114 in FIG. 1B surrounds prepolymer vessel 104, while jacket 114′ surrounds chain extender vessel 106. In addition, jacket 114 surrounds feed conduit 119 and recirculation conduit 105 and jacket 114′ surrounds feed conduit 119′ and recirculation conduit 105′. First heating system 110 may heat the fluid to a different temperature than second heating system 110′ heats its corresponding fluid in order to allow for independent heating of each component, e.g., heating of the prepolymer and/or chain extender. This embodiment may be desirable, for example, where the prepolymer and chain extender have significantly different viscosities at elevated temperature thereby necessitating heating to different temperatures in order to provide viscosities for the two components that are suitable for mixing thereof in mixing chamber 102. In the configuration shown in FIG. 1B, the mixing chamber 102 is unjacketed. This may be acceptable if the heat from the materials heated upstream of the mixing chamber is, on its own, sufficient to maintain the head temperature at a level acceptable for the materials being used. Preferably, the mixing chamber is independently heated with electrical resistance, or other heat source, to provide independent control of the mix head temperature relative to the prepolymer and curative temperature being used. Of course, in other embodiments, the mixing chamber may also be jacketed. Although in FIG. 1B, two heating systems 110, 110′ are shown, additional heating systems and elements may be employed in other embodiments of the present invention in order to carefully control the viscosities of the prepolymer and chain extender. Optionally, one heating system may be used to supply a heated fluid to both jackets 114, 114′. In another aspect, not shown, mixing chamber 102 is jacketed, and either heating system 110, 110′ or a third heating system (not shown) heats mixing chamber 102.

In the configurations shown in FIG. 1B, the heated fluid for the prepolymer vessel may be set at a first temperature while the heated fluid for the chain extender may be set to a different second temperature. This provides for the mixing of prepolymers and chain extenders having different elevated temperature viscosities, which allow embodiments of the present invention to use a broad range of prepolymer/chain extender combinations. As an example, a high viscosity prepolymer, e.g., an ester MDI-based prepolymer, may be reacted with a chain extender that is solid at room temperature, e.g., MOCA, in the RIM system of the present invention. In this aspect, the MOCA could be heated to a temperature higher than that to which the ester MDI-based prepolymer would be heated in order to provide a viscosity for the MOCA that is suitable for RIM processing. For example, the temperature of the heated fluid may be as high as 180° C., e.g., as high as 160° C., as high as 140° C. or as high as 120° C. In a preferred embodiment, to facilitate mixing of the two components, one or more of the chain extender and prepolymer are heated, optionally independently of one another, such that the difference in viscosities between the two components is less than 2000 cPs, e.g., less than 1000 cPs or less than 500 cPs. The difference in temperature between the prepolymer and chain extender (or vice versa) optionally is greater than 20° C., e.g., greater than 30° C. or greater than 50° C.

In FIG. 1C, heating system 110 comprises a jacket 114 that surrounds prepolymer vessel 104, feed conduit 119 and recirculation conduit 105, but not the corresponding structures for the chain extender vessel 106. In this configuration, the chain extender component in vessel 106 may have a viscosity at room temperature that is suitable to being used in the RIM system. Although in FIG. 1C, heating system 110 is shown as surrounding prepolymer vessel 104, in other embodiments, heating system 110 may surround either mixing chamber 102 or vessel 106.

In another embodiment, not shown, the heating system comprises a jacket that surrounds chain extender vessel 106, the feed conduit and the recirculation conduit associated with the chain extender vessel, but not the corresponding structures for the prepolymer vessel 104. In this configuration, the prepolymer component may have a viscosity at room temperature that is suitable to being used in the RIM system.

Although not shown in FIGS. 1A-1C, the RIM system may comprise additional parts such as conduits, chambers, pumps, valves, regulators, vents, meters, sensors and control devices. Depending on the type of metering pumps used and the viscosity of the materials being pumped, an additional pump, called a feed pump, may be employed to supply the metering pump with positive pressure, improving the performance of the metering pump. Such feed pump(s) may have their own recirculation loops back to the vessels, so that they can be operated with pressure control, at a flow rate higher than needed by the metering pump, such that the metering pump is guaranteed to have ample supply of material at acceptable pressure.

In addition, a recirculation groove may be employed in the control rod, for high pressure recirculation, and a recirculation bypass valve at or near the head, for low pressure recirculation. This allows recirculation of the components at low pressure (recirculation valve open) when the machine is idle and the need for filling molds is not imminent. This low pressure operation reduces stress and wear on the components that would otherwise be subject to continuous high pressure. When preparing to fill a mold, the recirculation valve is closed, and the machine enters high pressure recirculation. Material is thus forced through a small orifice in the head, which is the same orifice used to spray material into the mix chamber during mold filling. However, since the control rod is in the “closed” position, material is instead directed through a groove in the control rod to a point where it can return to the recirculation line, and thereby back to the vessel. When steady pressure and the correct flow rate are achieved, the control rod (and clean out rod, in the case of an “L” head) are rapidly moved to the “open” position, thereby opening the material path to the mold and closing the path to the recirculation line.

In addition, while FIGS. 1A -1C show only one prepolymer and one chain extender stream for each system, plural prepolymer and chain extender streams can be used in an analogous fashion, each with its own heating system, pump, and conduits. Alternatively, any number of these streams can share a heating system if it is not anticipated that they will require different operating temperatures. Such plural stream machines may be advantageous for molders wishing to use different polyurethane systems without the need for emptying, cleaning, and recharging prepolymer or chain extender materials in tanks, conduits, and associated equipment. In addition, plural chain extender streams allow the option of feeding two different chain extenders simultaneously, with the ratio of the two chain extenders adjustable to allow the molder to quickly and appropriately adjust the polyurethane properties based on the needs of the application at hand. Similarly, plural prepolymer streams allow the option of feeding two different prepolymers simultaneously, with the ratio of the two prepolymers adjustable to allow the molder to quickly and appropriately adjust the polyurethane properties for the needs of the application at hand.

In heated RIM systems such as those described herein, particular attention should be paid to “dead zones,” which are areas where material flow is insufficient. This may be a particular problem with the a high viscosity or solid prepolymer component, because of the inherent heat sensitivity and instability of such prepolymer materials. Rotary piston pumps, which are used in standard RIM systems, have been known to be susceptible to dead zones. Accordingly, metering pumps should be selected to minimize dead zone problems. The metering pumps preferably include axial piston pumps, radial piston pumps, gear-style pumps and hydraulically or mechanically driven cylinders. More specifically, suitable pumps include, for example, gear pumps and radial piston pumps made by Beinlich Pumpen GmbH and rotary piston pumps made by Rex-Roth.

Mixing chambers suitable for the present invention include chambers in which the prepolymer component may be mixed with the chain extender component. Conventional RIM systems are typically tailored to operate at prepolymer:chain extender weight ratios in the range of 3:1 to 1:3, with 1:1 being preferred, and are not well-suited for operating under the weight ratios that are desired with many RIM systems and processes that are capable of producing high performance polyurethane articles, such as the preferred RIM systems and processes of the present invention. For example, in some preferred embodiments, the mixing chamber and RIM system of the invention are capable of mixing a weight ratio of prepolymer to chain extender that is greater than 1:3, e.g., greater than 1:1, greater than 3:1, greater than 5:1 or greater than 8:1. In terms of upper range limits, the mixing chamber and RIM system are capable of mixing a weight ratio of prepolymer to chain extender that is less than 15:1, e.g., less than 10:1 or less than 5:1. In terms of ranges, the mixing chamber and RIM system preferably are capable of mixing a weight ratio of prepolymer to chain extender in a range from 1:3 to 15:1, e.g., 1:1 to 15:1 or 3:1 to 10:1.

In one embodiment, as described above, the mixing chamber includes a cylindrical housing with a hydraulically driven control rod disposed therein. The housing defines a prepolymer inlet and a chain extender inlet that are preferably opposite one another for supplying the respective components to the mixing chamber. The control rod is configured such that the control rod may block component flow to the mixing chamber, when fully inserted into the mixing chamber (closed position), or allow component flow into the mixing chamber when the control rod is retracted from the mixing chamber (open position). In the closed position, when the rod is moved forwardly toward the mold exit, the control rod blocks the flow of material, e.g., blocks the inlets, into the mixing chamber (and into the mold) thereby directing the flow of prepolymer and chain extender to respective recirculation conduits, optionally via grooves in the control rod, and optionally back to the respective vessels. Also, as the control rod is moved forward and into the closed position, the control rod engages the walls of the cylindrical housing to mechanically clean the walls and inhibit cured material from accumulating. To initiate mixing of the prepolymer and the chain extender, the rod is retracted away from the mold thereby allowing prepolymer and the chain extender to flow, preferably in a spray, into the mixing chamber from the respective inlets. The prepolymer and the chain extender flows ideally are highly pressurized such that when the control rod is in the mixing position, the prepolymer stream and the chain extender stream are impinged against one another thereby fully mixing the components. Once combined, the mixture is immediately conveyed out of the mixing chamber via a mixture outlet. Once out of the mixing chamber the reactive mixture is conveyed to a container, preferably a mold, where the mixture is shaped to form the polyurethane article.

As indicated above, in a preferred embodiment, the RIM system and process is suitable for mixing a prepolymer and chain extender at different rates in order to provide mixing at prepolymer:chain extender weight ratios that are greater than 1:1. In one aspect, the RIM system further comprises an L head, preferably a heated L head, for facilitating mixing of the prepolymer and the chain extender. The L head has an L-shaped mixing chamber, formed by the combination of two cylindrical head sections, each having a control/clean out rod. The use of such an L head design improves mixing of the component streams, particularly in cases where the weight ratio of prepolymer to curative is far from 1:1, as is generally desired for the high performance polyurethane systems of this invention. The L head is operated in a manner such that one control rod controls the entry of prepolymer and chain extender into the mixing chamber (as with the cylindrical housing, e.g., a single rod head), while the other rod, e.g., a clean out rod, opens and cleans the second part of the head, providing additional mixing area for the material. Mixing is improved for several reasons, including increased residence time, change in direction of flow, and ability to only partially retract the clean out rod, thereby creating a “pinch point” that creates turbulence between the first and second portions of the mixing chamber. Because the L housing provides better mixing capabilities, this embodiment is capable of effectively operating at a prepolymer to chain extender weight ratio that is greater than 1:1, greater than 3:1, greater than 5:1 or greater than 8:1. Such ratios are common with the high performance polyurethane formulations utilized by the present invention.

In another embodiment, the L housing includes seals as opposed to a tight fitting metal control rod. This allows for fluctuations in metal tolerances as temperatures change.

The present invention also relates to processes for producing a polyurethane article using an externally heated RIM system. In one embodiment, the process comprises injecting a prepolymer and a chain extender into a mixing chamber and initiating a curing of the mixture in a mixing chamber. According to the process, either or both the prepolymer and/or the chain extender is heated.

In one aspect, both the prepolymer and the chain extender are heated. In various embodiments, the prepolymer and chain extender components each have a high viscosity as described above and/or are solids at room temperature. The prepolymer and/or the chain extender components, for example, may have a melting point above 40° C., e.g., above 60° C., above 80° C. or above 100° C. In another embodiment, the process comprises injecting a prepolymer and a chain extender into a mixing chamber and initiating a curing of the prepolymer in a mixing chamber, wherein only one of the two components, i.e., either the prepolymer or the chain extender, is heated in order to reduce its viscosity.

In one embodiment, the process includes independently heating the prepolymer components and the chain extender components. In this aspect, as described above, heat is applied to vessels containing the respective components prior to the injecting of the prepolymer and chain extender into the mixing chamber. In another preferred embodiment, the independent heating of the prepolymer and the chain extender further comprises heating the parts of the RIM system used to feed the prepolymer and the chain extender to the mixing chamber. In another embodiment, the process includes heating the mixing chamber. In one embodiment, the heating systems of the present invention continuously heats all or a portion of the RIM system.

In another preferred embodiment, the process further comprises partially curing and/or substantially curing the reaction mixture in a mold to form the article. Following solidification in the mold and the attainment of sufficient physical properties to allow handling of the article without damaging, the article may be removed so that the mold can be immediately re-used to mold additional articles. The demolded article is then allowed to finish curing, for example, while cooling and/or subsequently at room temperature, or optionally, at elevated temperature in an oven.

### Polyurethane Article Properties

The above-described processes and systems of the invention preferably form articles having superior mechanical properties, which preferably render such articles suitable for high performance applications. Examples of such end uses includes: high performance tires, wheels, belts, scraper blades, mining screens, die cutting pads, pump parts, bearings, bushings, springs, track pads, abrasive pads, seals, and suspension parts for railroad, automotive, and heavy duty equipment.

An exemplary list of mechanical properties that may be considered for articles intended for such high performance applications includes, but is not limited to, the following: Shore® A Hardness, Shore® C Hardness, Shore® D Hardness, Young's Modulus of Elasticity, Trouser Tear and Tangent Delta.

Shore A Hardness

Hardness of polyurethane articles is an important characteristic for the high performance polyurethane articles formed by the systems and processes of the present invention. According to preferred aspects, the hardness is express in terms of the Shore® A Hardness, defined herein as the resistance to permanent indentation of a material as determined with a Shore® A durometer. A Shore® A durometer determines a hardness value for a given sample by applying pressure to the sample with a Durometer indenter foot. If the indenter foot completely penetrates the sample, a reading of 0 is obtained, and if no penetration occurs, a reading of 100 results. The reading is dimensionless. The corresponding ASTM test is designated ASTM D2240 00, the entirety of which is incorporated herein by reference. Shore® C and Shore® D are determined in similar manners, however, different durometers and different measurement scales are utilized for each.

Elasticity

The degree of elasticity or stiffness of the polyurethane articles of the present invention may be characterized by Young's modulus (E), also known as the modulus of elasticity. Young's modulus is defined as the ratio of the rate of tensile stress to tensile strain as indicated by the following formula:

$$E = \frac{tensile stress}{tensile strain} = \frac{σ}{ɛ} = \frac{F / {A}_{0}}{Δ L / {L}_{0}} = \frac{{FL}_{0}}{{A}_{0} Δ L}$$

wherein:

F is the force applied to the article;

A₀ is the original cross-sectional area through which the force is applied;

ΔL is the amount by which the length of the article changes; and

L₀ is the original length of the article.

Elasticity can be experimentally determined from the slope of a stress-strain curve created during tensile tests conducted on a sample of the material. The stress-strain curve for a particular sample is a graphical representation of the relationship between stress, derived from measuring the load applied on the sample, and strain, derived from measuring the deformation of the sample, i.e., elongation, compression, or distortion. In an exemplary procedure, a test specimen is prepared, e.g., die cut into a pre-determined shape, e.g., a rectangle, from a larger sheet of sample material. From the test specimen, the original cross-sectional area, A₀, is measured and recorded, as is the length, L₀. The test specimen may be temperature and/or humidity conditioned. As an example, the test specimen may be kept at up to 100% relative humidity, e.g., up to 75% relative humidity, up to 50% relative humidity or up to 25% relative humidity. As another example, the test specimen can be kept at up to 100° C., e.g., at least 75° C., at least 50° C., at least 25° C. or at least 0° C. The test specimen may, optionally, be kept at ambient temperature and/or humidity.

A load is then applied to the test specimen. An Instron® device may be utilized to apply the load to the test specimen. The Instron® device grips the test specimen on opposing ends and pulls the test specimen in opposing directions. The load application device, e.g., Instron® device, measures the force, F, utilized in pulling the specimen. The amount of elongation, ΔL, undergone by the test specimen is measured. Various F/ΔL data points are plotted to develop the stress-strain curve for the particular sample.

In addition to the stress-strain curve, the percent elongation can also be determined via this test procedure. To achieve this, the amount of elongation, ΔL, just prior to breakage is measured. This amount plus the initial length of the specimen is compared to the initial length to calculate the percent elongation.

“Trouser Tear”

The force necessary to propagate a tear in plastic film and thin sheeting by a single-tear method is often characterized by a Trouser Tear test. The corresponding ASTM test is designated ASTM D-1938, the entirety of which is incorporated herein by reference. This test method rates the tear propagation resistance of various samples of comparable thickness. In the Trouser Tear procedure, specimens are cut into 1 inch (2.5 cm) by 3 inch (7.5 cm) rectangles. A 2 inch (50 mm) cut is made down the center of each specimen leaving a “trouser-shaped” specimen having two equally sized legs. Unless otherwise specified, the test specimen is temperature and humidity conditioned, to 50% humidity and 23° C. Conditions can be otherwise specified, e.g., the test specimen can be kept at up to 100% relative humidity, e.g. up to 75% relative humidity, up to 50% relative humidity or up to 25% relative humidity. As another example, the test specimen can be kept at up to 100° C., e.g., at least 75° C., at least 50° C., at least 25° C. or at least 0° C.

A load is then applied to the legs of the test specimen. In an exemplary embodiment, a tensile tester such as an Instron® unit is utilized to apply the load to the test specimen. One grip of the Instron® is attached to one leg and the other grip of the Instron® is attached to the other leg. The load application device, e.g., Instron® device, pulls each of the legs of the test specimen in opposing directions. The Instron® device measures the force, F, utilized in pulling the specimen. As the legs are pulled apart from one another, the tear propagates. The test can be continued until the tear propagates through the remaining 1 inch (25 mm) of the length of the sample. The Instron® specifies the force utilized in pulling the specimen and the rate of separation of the grips. The time elapsed until the tear propagates through the specimen, e.g., until the specimen is broken into multiple pieces, is measured.

Modulus of Elasticity, Tensile Strength

The tensile strength, tensile modulus and percent elongation are often characterized by a tensile tear test. The corresponding ASTM test is designated ASTM D412, the entirety of which is incorporated herein by reference.

The testing involves a sample that is cut into a dumbbell shaped specimen. The test specimen is gripped at opposite ends and a load is applied thereto. In an exemplary embodiment, an Instron® device is utilized to apply the load to the test specimen. The load application device, e.g., Instron® device, grips the test specimen on the opposing ends and pulls the test specimen in opposing directions. The Instron® device can measure the force, F, utilized in pulling the specimen. In an exemplary test procedure, the specimen is pulled until it ruptures. The force required to rupture the sample is the maximum tensile strength of the specimen. The amount of elongation, ΔL, undergone by the test specimen can be measured as well. The Instron device measures and records modulus of elasticity and/or tensile strength.

Tangent Delta (tan δ)

The modulus and viscoelastic properties of a particular sample in relation to temperature is often characterized by dynamic mechanical analysis (DMA), including tan δ, loss modulus and storage modulus measurements. To obtain tan δ values, a rheometric measurement device, e.g. a TA Ares® RDA, is utilized. A specimen of a particular size and shape, e.g., a rectangle, is prepared. The sample is formed, e.g., die cut, into a rectangle of the dimensions 1.5 inches (3.75 cm) by 0.5 inches (1.25 cm) by 0.25 inches (0.68 cm). The specimen is subjected to a known strain by the TA Ares® RDA. The storage modulus, G′, and the loss modulus, G″, are then obtained for the particular specimen by the TA Ares® RDA. The storage modulus, G′, relates to the storage portion of the specimen. As the specimen is cycled through a specified strain, energy is put into the specimen. As it is released, the all of the stored energy is given back. The loss modulus, G″, relates to the absorption portion of the specimen. As the specimen is deflected or compressed, energy is absorbed into the specimen. As the specimen is released from deflection or compression, all of the energy is not given back. The ratio of the loss modulus, G″, and the storage modulus, G′, is equal to the tan δ.

The values for tan δ can be plotted versus temperature. The temperature at which the minimum tangent delta occurs, i.e., where the tan δ bottoms out, will be the critical temperature, T_{c}. In various optional embodiments, the polyurethane composition s has a T_{c} greater than 70° C., e.g., greater than 100° C. or greater than 110° C. In a preferred example, T_{c} is 110° C. At temperatures up to and below T_{c}, the sample material will not melt or thermally break down under the known strain. At temperatures higher than T_{c}, the sample material will melt or break down due to runaway temperature increase under the same strain.

Polyurethane elastomer applications often build heat as a result of hysteresis during flexing. For example, the polyurethane elastomers in a solid or structured wheel flex once per revolution generating heat. If temperatures rise too high, internal melting of the polyurethane can cause a failure of the wheel. Even if internal melting does not occur, the increase in temperature can cause the material to soften (lower modulus), reducing its ability to carry high loads. Also, the physical properties of elastomers are generally lower at elevated temperatures, resulting in increase in wear and decrease in tear resistance. Thus it is advantageous for a polyurethane to have a low tangent delta and to maintain its modulus as the temperature rises.

Split Tear (ASTM D470)

The force required to initiate a tear in a plastic or elastomer material is often measured by the ASTM D470 split tear test, the entirety of which is incorporated herein by reference. In this test, a sample 5.08 cm long, 0.635 cm wide, and 0.1 to 0.38 cm thick (nominally 0.19 cm thickness) and flared (wider) at one end is slit with a razor blade down the length of the sample, ending 0.381 cm from the flared end of the sample. As with the Trouser tear, the “legs” of the test specimen, after appropriate conditioning of the sample, are clamped into the jaws of a tensile tester (such as an Instron®), and pulled in opposite directions at a rate of 50 cm/min. Force vs. position data of the jaws is recorded, and load/thickness is calculated as the tear strength of the material.

Die C Tear (ASTM D624)

The die C tear measures tear strength using a plastic or elastomer sheet of thickness similar to that used for the trouser and the split tear. The shape of the test specimen is cut in a “C” shape, with a right angle on the inside edge of the “C”. This is the point of greatest stress concentration. For drawings and dimensions, see ASTM D624, the entirety of which is incorporated herein by reference. The two ends of the “C” are clamped in the tensile tester, and pulled in opposite directions at a rate of 50 cm/min. Force vs. position data of the jaws is recorded, and the tear strength is calculated as the maximum load/thickness.

### EXAMPLES

The advantages and the important features of the present invention will be more apparent in view of the following non-limiting Examples.

Tables 1A and 1B set forth the prepolymer and chain extenter components, respectively, utilized in the following Examples.

TABLE 1A
PREPOLYMERS

| | | | | Viscosity | Viscosity | Viscosity |
|---|---|---|---|---|---|---|
| | | | Physical | @ 25 C. | @ 70 C. | @ 100 C. |
| PREPOLYMERS | Type | % NCO | Form @ RT | (cps) | (cps) | (cps) |
| ADIPRENE ® LF 1800 | TDI/Ester | 3.2 | Solid | — | 2800 | 650 |
| ADIPRENE ® LF 1900 | TDI/Ester | 4.1 | Solid | — | 2500 | 500 |
| ADIPRENE ® LF 1950 | TDI/Ester | 5.4 | Solid | — | 600 | 300 |
| ADIPRENE ® LF 950 | TDI/Ether | 6.1 | Viscous | >6000 | 500 | 150 |
| | | | Liquid | | | |
| VIBRATHANE ® 8585 | MDI/Ester | 6.7 | Solid | — | 2400 | 700 |
| VIBRATHANE ® 8595 | MDI/Ester | 9.6 | Solid | — | — | 400 |
| VIBRATHANE ® B625 | MDI/Ether | 6.2 | Viscous | >8000 | — | 800 |
| | | | Liquid | | | |
| VIBRATHANE ® B836 | MDI/Ether | 8.8 | Viscous | >8000 | — | 400 |
| | | | Liquid | | | |
| BAYFLEX ® MP-5000 | MDI/Ether | — | Liquid | 700/1350¹ | — | — |
| BAYFLEX ® MP-10000 | MDI/Ether | — | Liquid | 700/1350 | — | — |
| BAYFLEX ® MP-25000 | MDI/Ether | — | Liquid | 700/1200 | — | — |
| BAYFLEX ® XGT-80 | MDI/Ether | 22.6 | Liquid | 750/550 | — | — |
| BAYFLEX ® SGT-140 | MDI/Ether | 22.8 | Liquid | 750/550 | — | — |
| BAYFLEX ® 110-50 | MDI/Ether | — | Liquid | 750/1300 | — | — |
| BAYFLEX ® XGT-16 | MDI/Ether | 22.8 | Liquid | 750/600 | — | — |
| VIBRARIM ® 813A | MDI/Ether | 16.5 | Liquid | 5000 | — | — |

¹Viscosity for BAYFLEX ® products is denoted as Part A (isocyanate)/Part B (polyether)

TABLE 1B
CHAIN EXTENDERS

| | | Equivalent | Physical | Melting | | |
|---|---|---|---|---|---|---|
| CHAIN EXTENDERS | | Weight | Form @ RT | Point, C. | Viscosity | |
| LONZACURE ® | MDEA | 156 | Solid | 87-89 | — | |
| ETHACURE ® 100 | DETDA | 89 | Liquid | — | Low | — |
| | | | | | Viscosity | |
| ETHACURE ® 300 | DETDA | 107 | Liquid | — | Low | — |
| | | | | | Viscosity | |
| JEFFAMINE ® SD401 | Amine- | 200 | Liquid | — | Low | — |
| | terminated | | | | Viscosity | |
| | Polyether | | | | | |
| JEFFAMINE ® SD2001 | Amine- | 1000 | Liquid | — | Low | — |
| | terminated | | | | Viscosity | |
| | Polyether | | | | | |
| VIBRACURE ® 133 | MOCA | 133 | Solid | 110 | — | — |
| Butanediol | BDO | 45 | Liquid | — | Low | — |
| | | | | | Viscosity | |
| Fomrez 22-114 | Polyester | 490 | Solid | 50 | Viscous | — |
| | polyol | | | | Liquid | |
| Hexanediol | HDO | 59 | Solid | 42 | Low | — |
| | | | | | Viscosity | |

The elastomers of the following Examples were formed using a two component RIM system that was heated primarily with two independent oil heating systems. One oil heating system was utilized on the prepolymer side, and the other oil heating system was utilized on the chain extender side. Oil was used to heat tanks and lines, while electrical tracing and heating elements were used on the head, and on fittings that were difficult to heat with oil. The prepolymer and the chain extender were injected into an “L” mixing head, at pressures of about 2000 psi (13790 kPa), unless otherwise noted. Material exiting the head was injected into a large, oil heated test mold held at about 104° C., unless otherwise noted. Samples were allowed to remain in the mold until they had reached physical strength sufficient to demold without damage. Samples were then post cured at 100° C. to 115° C. for 16 hrs before allowing to cool to room temperature, unless otherwise noted. Samples were held for at least 7 days before testing according to various ASTM methods.

### Example 1

ADIPRENE® LF1800 was heated in sealed 5 gallon (19 liter) pails overnight in a 70° C. circulating air oven. It was then charged to a prepolymer vessel of a RIM machine, heated to 93° C., and degassed by application of vacuum while agitating. The lines of the prepolymer side of the RIM machine were also preheated to 93° C. Vacuum was stopped, and the prepolymer vessel was blanketed with nitrogen to 5 psi (34 kPa). Circulation of prepolymer was established through the valves, lines, pumps, meters, mix head recirculation valves, and back to the prepolymer vessel.

As the prepolymer was being heated, 4,4′-methylenebis[2,6-diethyl]aniline (MDEA) (m.p. 87-89° C.) was charged in powder form to the chain extender vessel. The chain extender vessel temperature was set to 105° C. Once the MDEA was sufficiently molten to allow agitation, the agitator was started. At this point the chain extender side lines were also preheated with the 121° C. oil. Once fully molten, vacuum was applied to degas the MDEA. Once degassed, vacuum was stopped, and the tank was blanketed with nitrogen to 5 psi (34 kPa). Circulation of the chain extender was established through the valves, lines, pumps, meter, mix head recirculation valve, and back to the chain extender vessel.

Pump speeds were set for a total of 300 gm/sec, and at a ratio consistent with a mix ratio of prepolymer to chain extender that equated to 95% theory. That is, the amount of chain extender being pumped was set to 95 equivalent % of the amount of prepolymer being pumped, based on the % NCO of the prepolymer, and the active primary amine or hydroxyl content of the chain extender. Calibration shots were taken of each stream individually at 2000 psi (13790 kPa), and the meters were calibrated to read accurately via the software of the RIM machine control system.

The RIM head was mated with an oil heated mold set to 105° C. An elastomer gasket and clamp were used to prevent leakage or air entrainment at the interface. The RIM machine was pressured up to 2000 psi (13790 kPa), and the meters were consulted to verify correct flow rates. The START button was pressed and the hydraulic cylinders of the “L” head opened to allow the two streams to mix in the head and fill the mold. After a preprogrammed shot time had elapsed, the hydraulic system automatically closed the head, thereby cleaning out the mixing chamber.

The mold was left closed until a small amount of polyurethane mixture that had been vented from the mold appeared to be tough and elastomeric. The mold was opened and the test part was removed and placed into a 115° C. oven for a 16 hr post-cure. The mold was cleaned, mold released, and closed for use on the next shot.

After the 16 hr post-cure, the fully cured elastomeric test part was allowed to stand at least an additional seven days at room temperature. After this time, test parts were cut and tested for properties, according to applicable ASTM standards.

### Example 2

Example 1 was repeated with a liquid chain extender, diethyltoluenediamine (DETDA), commercially available as ETHACURE® 100 by Albemarle Corporation, in place of MDEA. Since DETDA is a room temperature liquid it was charged at room temperature and processed at low temperature 40° C. (104° F.).

### Example 3

Example 2 was repeated using ADIPRENE® LF1900 instead of ADIPRENE® LF1800 on the prepolymer side. The ADIPRENE LF1900, which is a solid at room temperature, was processed at 93° C. (200° F.).

### Example 4

Example 3 was repeated using a mixture of DETDA and JEFFAMINE® SD401 (amine terminated polyether, M.W. 515) in place of pure DETDA. The weight ratio of DETDA to JEFFAMINE SD401 was 1.9:1. The temperatures used for the prepolymer and chain extender were the same as in Example 2.

### Example 5

Example 1 was repeated, using VIBRATHANE® 8585 prepolymer in the prepolymer vessel (processed at 93° C. (200° F.)) and a combination of 4,4′methylene bis (2-chloroaniline) (MOCA), available commercial as VIBRACURE® 133, and JEFFAMINE® SD401 in the chain extender vessel. The weight ratio of MOCA to JEFFAMINE® SD401 was 1 to 1. The chain extender vessel was set to 121° C. (250° F.).

### Example 6

Example 5 was repeated with JEFFAMINE® SD2001(amine terminated polyether, M.W.2050) in place of JEFFAMINE® SD401. The weight ratio of MOCA to JEFFAMINE® SD2001 was 1:1.2.

### Example 7

Example 1 was repeated using VIBRATHANE® 8595 prepolymer in the prepolymer vessel (processed at 93° C. (200° F.)) and a combination of Fomrez 22-114 polyester polyol and butanediol in the chain extender vessel (processed at 74° C. (165° F.)) at a weight percent ratio of 3.3 to 1. A catalyst, dioctyltin dimercaptide, commercially available as FOMREZ® UL-32, was used to reduce the potlife and demold times.

### Example 8

Example 1 was repeated with VIBRATHANE® 8595 prepolymer in the prepolymer vessel (processed at 93° C. (200° F.)) and MOCA in the chain extender vessel. The chain extender vessel was set to 121° C. (250° F.).

### Example 9

Example 8 was repeated with VIBRATHANE® 8585 prepolymer in the prepolymer vessel (processed at 93° C. (200° F.)).

### Example 10

Example 9 was repeated with dimethylthiotoluenediamine (DMTDA). available commercially as ETHACURE® 300 by Albemarle Corporation, was used in place of MOCA in the chain extender vessel. The chain extender vessel was set to 30° C. (85° F.).

### Example 11

Example 1 was repeated with VIBRATHANE® B625 prepolymer (processed at 82° C. (180° F.)) in the prepolymer vessel, and MOCA (processed at 121° C. (250° F.)) in the chain extender vessel.

### Example 12

Example 11 was repeated with VIBRATHANE® B 836 prepolymer (processed at 82° C. (180° F.)) in the prepolymer vessel.

### Example 13

Example 12 was repeated using polytetramethylene ether glycol (PTMEG) and butanediol in a 1 to 1 weight ratio in the chain extender vessel. A catalyst, dimethyl tin carboxylate, commercially available as FOMREZ® UL-28, was used to reduce the potlife and demold times.

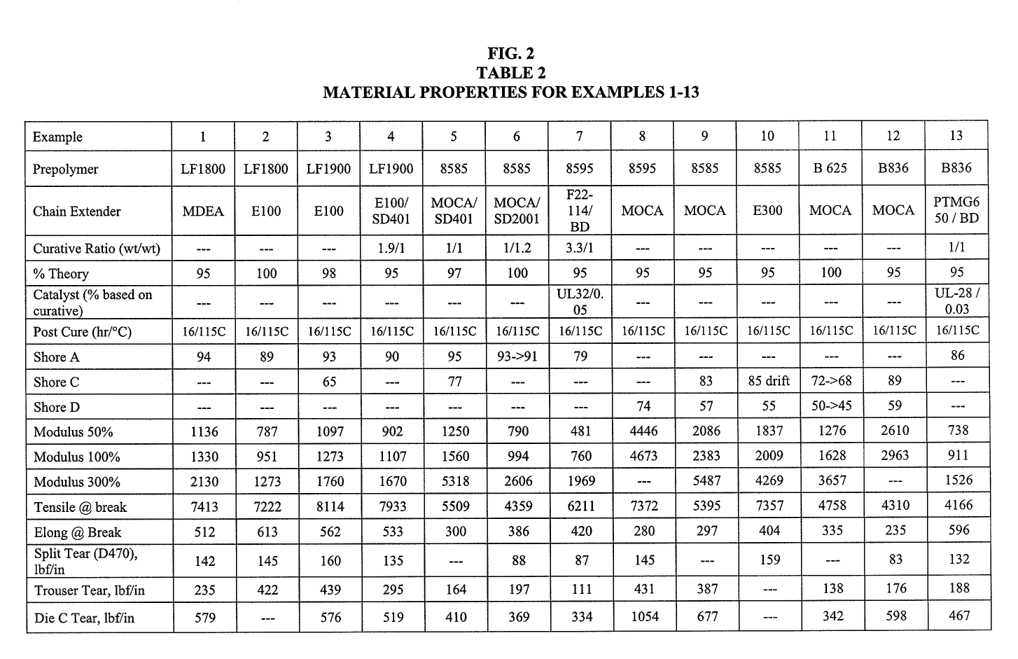

The material properties for the polyurethane articles formed in Examples 1-13 are shown in Table 2 (See FIG. 2).

### Example 14

### (Undesirably Fast Gel Time)

Example 1 was repeated, but with VIBRATHANE® 8585 in place of LF1800 (processed at 82° C. (180° F.)) and DETDA in place of MDEA. Since DETDA is a liquid at room temperature, it was charged as such, and processed at 40° C. (104° F.). Gel time was expected to be very short, because of the known high reactivity of both MDI prepolymers and DETDA. Therefore, a one second shot was taken in a cup to determine approximate gel time. The system was found to have a gel time of about 1 second. The mold was connected to the mix head via a gasket and clamp, and an attempt was made to fill the mold as best possible. However, mold filling was incomplete as a result of the fast gel time, resulting in failure of the gasket, and material shooting out and onto the floor. The partially formed part had some flow lines indicative of a possible mix problem. No testing was performed on this material.

### Comparative Examples

### Comparative Examples A-H

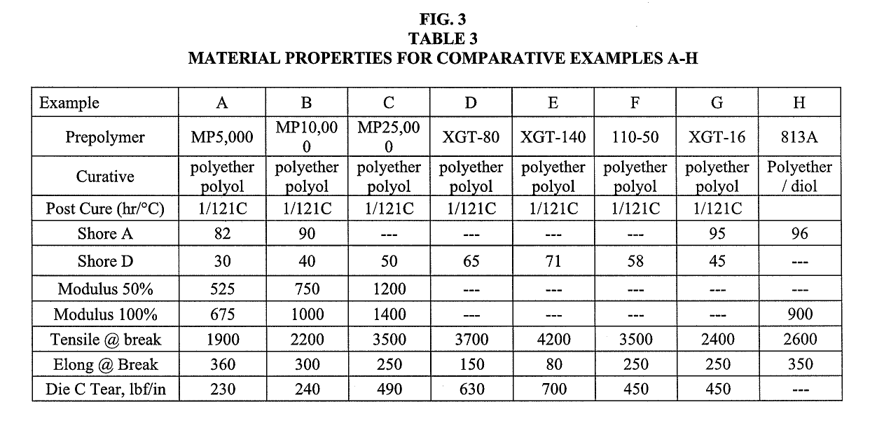

Published properties of the following RIM prepolymer/chain extender combinations are listed for comparison in Table 3 (See FIG. 3): BAYFLEX® MP-5000, BAYFLEX® MP-10000, BAYFLEX®-25,000, BAYFLEX® XGT-80, BAYFLEX® XGT-140, BAYFLEX® 110-50, BAYFLEX® XGT-16 (Bayer Corp) and VIBRARIM® 813A (Chemtura Corp.). Each of these combinations includes a MDI prepolymer and a polyether polyol. Properties of these existing RIM component combinations within a similar hardness and modulus range are generally lower than those of the combinations utilized in the RIM system and process of the invention, listed in Table 2 (See FIG. 2). It should be noted that these components are processed without external heat. This trend is illustrated when comparing Examples 1-7, and 13 with Comparative Examples A, B, C, G and H and Examples 8, 9, 10, 11, and 12 with Comparative Examples C, D, E and F.

### Comparative Examples I-O

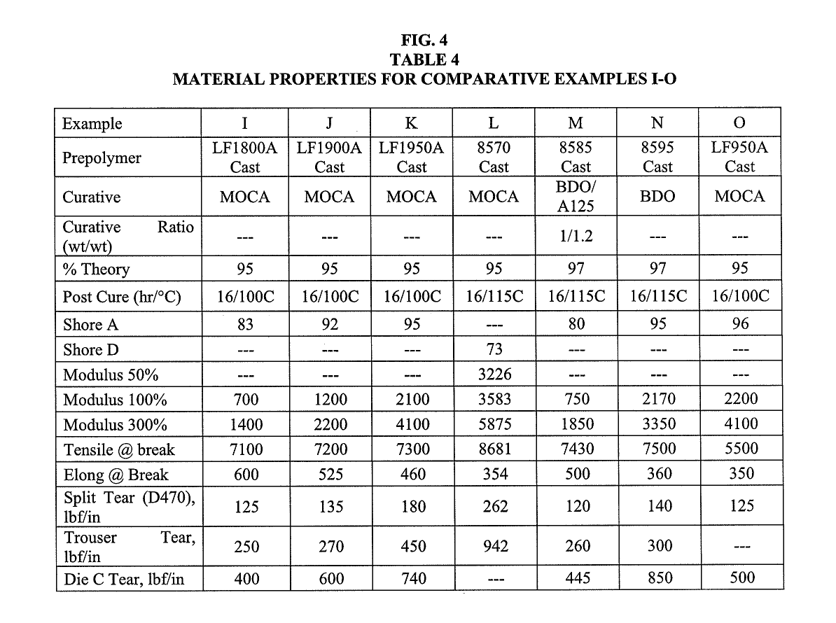

Published properties of the following commercial hot cast polyurethane prepolymer/chain extender combinations are also listed for comparison in Table 4 (See FIG. 4): ADIPRENE® LF 1800/MOCA; ADIPRENE® LF1900/MOCA; ADIPRENE® LF1950/MOCA; VIBRATHANE® 8570/MOCA; VIBRATHANE® 8585/MOCA; VIBRATHANE® 8595/MOCA; ADIPRENE( LF950/MOCA; VIBRATHANE® 8595/BD; and VIBRATHANE® 8585/BD-A125. Properties of these hot cast polyurethane prepolymer/chain extender combinations within a specific hardness and modulus range are similar to those of the combinations utilized in the RIM process of the invention. This is illustrated by comparing Examples 1-7 and 13 with Comparative Examples I thru O. It should be noted, however, that processing costs are much higher for a hot cast process than for a RIM process.

The dynamic properties of Example 8 as well as the published physical properties of Comparative Example L, the commercial hot cast polyurethane VIBRATHANE® 8570-MOCA combination, are presented for comparison in Table 5. While one of the goals of the present invention has been to meet the performance of hot cast properties with lower cost hot RIM, it has surprisingly and unexpectedly been found that the dynamic properties of the RIM-processed combinations can be improved over standard polyurethane combinations processed via a hot cast process. Hard esters such as Comparative Example L are known to be difficult to formulate with superior dynamic properties.

TABLE 5
HOT CAST PROPERTIES COMPARED WITH RIM PROPERTIES

Example

| | 8 | L |
|---|---|---|
| Prepolymer | 8595 | 8570 |
| | Heated | Cast |
| | RIM | |
| Curative | MOCA | MOCA |
| % Theory | 95 | 95 |
| Hardness | 74D | 73D |
| Tangent Delta | — | — |
| 4% Strain, 10 Hz | | |
| 30° C. | 0.095 | 0.223 |
| 50° C. | 0.106 | 0.225 |
| 70° C. | 0.103 | 0.174 |
| 100° C. | 0.076 | 0.080 |
| 150° C. | 0.050 | 0.047 |
| Storage Mod, G′ | — | — |
| (dyn/cm²) × 10⁸ | | |
| 30° C. | 30.1 | 16.8 |
| 50° C. | 18.8 | 7.02 |
| 70° C. | 13.1 | 4.00 |
| 100° C. | 9.45 | 2.88 |
| 150° C. | 5.94 | 2.38 |

Any feature described or claimed with respect to any disclosed implementation may be combined in any combination with any one or more other feature(s) described or claimed with respect to any other disclosed implementation or implementations, to the extent that the features are not necessarily technically incompatible, and all such combinations are within the scope of the present invention. Furthermore, the claims appended below set forth some non-limiting combinations of features within the scope of the invention, but also contemplated as being within the scope of the invention are all possible combinations of the subject matter of any two or more of the claims, in any possible combination, provided that the combination is not necessarily technically incompatible.

What is claimed is:

1. An externally heated reaction injection molding system in communication with a prepolymer storage vessel and a chain extender storage vessel.

2. The system of claim 1, wherein the system comprises:
a mixing chamber for combining a prepolymer and a chain extender; and
a heating system for heating at least one of the prepolymer and the chain extender upstream of the mixing chamber and downstream of the storage vessels.

3. The system of claim 2, wherein the heating system heats one or more conduits between the mixing chamber and at least one of the prepolymer storage vessel or the chain extender storage vessel.

4. The system of claim 3, wherein at least one of the prepolymer storage vessel or the chain extender storage vessel are heated.

5. The system of claim 2, wherein the system is capable of heating at least one of the prepolymer and the chain extender to a temperature greater than 70° C.

6. The system of claim 2, wherein the system is capable of heating at least one of the prepolymer and the chain extender to a temperature greater than 100° C.

7. The system of claim 2, wherein the system is capable of employing at least one of a prepolymer and a chain extender having a room temperature viscosity greater than 3000 centipoise.

8. The system of claim 2, wherein the system is capable of employing at least one of a prepolymer or a chain extender that is a solid at room temperature.

9. The system of claim 2, wherein the system is capable of employing at least one of a prepolymer or a chain extender having a melting point in the range of 40° C.-140° C.

10. The system of claim 2, further comprising:
a first conduit in fluid communication with the prepolymer storage vessel;
a first pump in fluid communication with the prepolymer storage vessel for pumping prepolymer through the first conduit to the mixing chamber;
a second conduit in fluid communication with the chain extender storage vessel; and
a second pump in fluid communication with the chain extender storage vessel for pumping chain extender through the second conduit to the mixing chamber.

11. The system of claim 10, further comprising a first heating system for independently heating the prepolymer and a second heating system for independently heating the chain extender.

12. The system of claim 11, wherein the first heating system comprises a first heated fluid that circulates around at least a portion of the prepolymer storage vessel, and wherein the second heating system comprises a second heated fluid that circulates around at least a portion of the chain extender storage vessel.

13. The system of claim 2, wherein the mixing chamber comprises an L head for mixing the prepolymer and the chain extender.

14. The system of claim 2, wherein the system is capable of combining the prepolymer and the chain extender at a weight ratio of from 3:1 to 10:1.

15. The system of claim 2, wherein the system is capable of combining the prepolymer and the chain extender at a weight ratio greater than 5:1.

16. A process for producing an article in a reaction injection molding system, the process comprising the steps of:
(a) injecting a prepolymer and a chain extender into a mixing chamber, wherein at least one of the prepolymer and the chain extender is heated; and
(b) initiating a curing of the prepolymer in the mixing chamber, wherein the prepolymer and the chain extender have a gel time greater than 2 seconds.

17. The process of claim 16, wherein the gel time is greater than 4 seconds.

18. The process of claim 16, wherein the at least one of the prepolymer and the chain extender that is heated has a viscosity at 25° C. that is greater than 3000 centipoise.

19. The process of claim 16, wherein the at least one of the prepolymer and the chain extender that is heated has a viscosity at 25° C. that is greater than 5000 centipoise.

20. The process of claim 16, wherein the viscosity of the at least one of the prepolymer and the chain extender that is heated is reduced by at least 2000 centipoise.

21. The process of claim 16, wherein the viscosity of the at least one of the prepolymer and the chain extender that is heated is reduced by at least 4000 centipoise.

22. The process of claim 16, wherein the chain extender is in solid form at room temperature.

23. The process of claim 16, wherein the prepolymer is in solid form at room temperature.

24. The process of claim 16, wherein at least one of the prepolymer and the chain extender is heated to a temperature above 70° C.

25. The process of claim 16, wherein at least one of the prepolymer and the chain extender is heated to a temperature above 100° C.

26. The process of claim 16, further comprising the step of:
heating the mixing chamber.

27. The process of claim 16, further comprising the step of:
independently heating at least one of the prepolymer and the chain extender.

28. The process of claim 16, wherein the chain extender has a melting point in the range of 40° C.-140° C.

29. The process of claim 16, wherein the chain extender has a melting point greater than 60° C.

30. The process of claim 16, wherein the prepolymer has a melting point in the range of 60° C.-120° C.

31. The process of claim 16, wherein the prepolymer has a melting point greater than 60° C.

32. The process of claim 16, wherein the prepolymer has a NCO content of 2 to 12%.

33. The process of claim 16, wherein the prepolymer has a NCO content of less than 15%.

34. The process of claim 16, wherein at least one of the prepolymer and the chain extender has a melting point below 50° C.

35. The process of claim 16, wherein the chain extender is a halogenated aromatic diamine.

36. The process of claim 16, wherein the chain extender is a halogenated diaromatic diamine.

37. The process of claim 16, wherein the chain extender is selected from the group consisting of methylene bis orthochloroaniline (MOCA), methylene bis diethylanaline (MDEA), methylene bis chlorodiethylanaline (MCDEA), and hydroquinone-bis-hydroxyethyl ether (HQEE).

38. The process of claim 16, wherein the prepolymer is a toluene diisocyanate(“TDI”)-based prepolymer.

39. The process of claim 16, wherein the prepolymer is a diphenylmethane diisocyanate (“MDI”)-based prepolymers.

40. The process of claim 16, wherein the prepolymer is MDI-based and the chain extender is DMTDA.

41. The process of claim 16, wherein the prepolymer is TDI-based and the chain extender is selected from the group consisting of MDEA and MCDEA.

42. The process of claim 16, wherein the prepolymer is TDI-based and the chain extender is DETDA.

43. The process of claim 16, wherein the prepolymer is MDI-based and the chain extender is selected from the group consisting of MOCA and MCDEA.

44. The process of claim 43, wherein the article has a hardness of 45 to 85 Shore D.

45. The process of claim 43, wherein the article softens by less than 30 Shore D units when heated to 150° C.

46. The process of claim 16, wherein the prepolymer is the reaction product of a polyol and an aromatic diisocyanate and the chain extender is a diaromatic diamine.

47. A process for producing an article in a reaction injection molding system, the process comprising the steps of:
(a) injecting a prepolymer and a chain extender into a mixing chamber to form a reaction mixture, wherein at least one of the prepolymer or chain extender is heated to reduce its viscosity by at least 2000 centipoise relative to room temperature;
(b) directing the reaction mixture into a mold; and
(c) curing the reaction mixture to form the article.

48. The process of claim 47, wherein the prepolymer and the chain extender have a gel time greater than 2 seconds.

49. The process of claim 47, wherein the prepolymer and the chain extender have a gel time greater than 4 seconds.

50. The process of claim 47, wherein the prepolymer is heated.

51. The process of claim 47, wherein the chain extender is heated.

52. The process of claim 47, wherein both the prepolymer and the chain extender are heated.

53. The process of claim 47, wherein the viscosity is reduced by at least 2000 centipoise.

54. The process of claim 47, wherein the viscosity is reduced by at least 4000 centipoise.
